(19) United States
(12) Patent Application Publication
(10) Pub. No.: US 2005/0178369 A1
(43) Pub. Date: Aug. 18, 2005

(54) Vapor fuel system and method for evaporative fuel vapor engine

(75) Inventor: Craig Andrew Weldon, Ontario (CA)

Correspondence Address: MORGAN LEWIS & BOCKIUS LLP, 1111 PENNSYLVANIA AVENUE NW, WASHINGTON, DC, 20004, US

(73) Assignee: Siemens VDO Automotive Corporation

(21) Appl. No.: 10/777,183

(22) Filed: Feb. 13, 2004

(51) Int. Cl. F02M 21/06

(52) U.S. Cl. 123/525

(57) ABSTRACT

A vapor fuel generation and management system for an evaporative fuel vapor engine includes a fuel tank that stores an evaporative liquid fuel, and a carbon canister connected to the headspace of the fuel tank to absorb and retain fuel vapor. A fuel vaporization unit has a liquid fuel inlet in communication with a liquid fuel outlet of the fuel tank, and a fuel vapor inlet in communication with the carbon canister. The fuel vaporization unit generates vapor fuel, i.e. a rich air/fuel mixture, and has a vapor fuel outlet in communication with an engine intake manifold. The fuel vaporization includes a stationary diffuser member that assists in generating the vapor fuel. A purge valve controls vapor fuel flow to the engine intake manifold.

### FIELD OF THE INVENTION

This invention relates to a fuel system for an evaporative fuel vapor engine, and more particularly to a vapor fuel generation and management system for an evaporative fuel vapor engine of an automobile.

### BACKGROUND OF THE INVENTION

Fuel systems for most modem automotive engines utilize fuel injectors to deliver liquid fuel to the engine cylinders for combustion. The fuel injectors are mounted on a fuel rail to which liquid fuel is supplied from a liquid fuel tank by a pump. A pressure regulator maintains the required injector operational pressure. Excess liquid fuel that is not injected to the cylinders may be returned to the fuel tank by a fuel return line.

The generation of vapor in the liquid fuel tank may require a secondary system, i.e an evaporative emission control system, for controlling vapor emissions from the liquid fuel in the fuel tank. The evaporative emission control system includes a fuel vapor collection canister, e.g. a carbon or charcoal canister, that is connected to the headspace of the fuel tank to absorb and retain fuel vapor. The evaporative emission control system further includes a canister purge valve between the fuel tank and an intake manifold of the engine. An engine control management computer supplies a control signal for operating the canister purge valve to allow vapor flow from the tank headspace and the vapor collection canister to the engine intake manifold, where the vapor is consumed in the combustion process.

It is believed that there is a need for a fuel system that controls vapor emissions, and that generates and supplies vapor fuel, to an evaporative fuel vapor engine, thus modifying or eliminating the need for liquid fuel delivery to the engine cylinders.

### SUMMARY OF THE INVENTION

The invention provides a vapor fuel generation and management system that uses liquid fuel from a liquid fuel tank, and fuel vapor from the head space of the liquid fuel tank, to create vapor fuel for use in an evaporative fuel vapor engine. An embodiment provides a vapor fuel generation and management system for an evaporative fuel vapor engine. The vapor fuel generation and management system includes a fuel tank that defines a chamber adapted to store an evaporative liquid fuel. The fuel tank has a liquid fuel outlet and a fuel vapor outlet. The system includes a carbon canister in communication with the fuel vapor outlet of the fuel tank. The vapor fuel generation and management system includes a fuel vaporization unit that generates vapor fuel, and has a liquid fuel inlet in communication with the liquid fuel outlet of the fuel tank, a fuel vapor inlet in communication with the carbon canister, and a vapor fuel outlet in communication with an engine intake manifold. The fuel vaporization unit includes a stationary diffuser member. The vapor fuel generation and management system includes a purge valve that controls vapor fuel flow to the engine intake manifold.

The fuel vaporization unit may include a housing having a wall defining a chamber. The housing chamber may have a lower portion forming a liquid fuel bath, and an upper portion forming a vapor fuel space. The liquid fuel inlet of the fuel vaporization unit may include a first port in the housing wall, the fuel vapor inlet of the fuel vaporization unit may include a second port in the housing wall proximate the upper portion, and the vapor fuel outlet of the fuel vaporization unit may include a third port in the housing wall proximate the upper portion. The fuel vaporization unit may include a liquid fuel outlet in communication with a liquid fuel inlet of the fuel tank. The liquid fuel outlet of the fuel vaporization unit may include a fourth port in the housing wall proximate the lower portion. The fuel vaporization unit may include a liquid fuel level sensor in the lower portion. The evaporative liquid fuel of the vapor fuel generation and management system may be gasoline.

An embodiment of the invention also provides a fuel vaporization unit of a vapor fuel generation and management system for an evaporative fuel vapor engine. The fuel vaporization unit includes a housing having a wall defining a chamber. The housing chamber has a lower portion forming a liquid fuel space, and an upper portion forming a vapor fuel space. A liquid fuel inlet port may be formed in the housing wall, a fuel vapor inlet port may be formed in the housing wall proximate the upper portion, a vapor fuel outlet port may be formed in the housing wall proximate the upper portion, and a liquid fuel outlet port may be formed in the housing wall proximate the lower portion. The fuel vaporization includes a stationary diffuser member at least partially disposed in the upper portion for dispersing flow of a liquid fuel.

The diffuser member may include an upper portion, a lower portion, and a surface extending from the upper portion to the lower portion. The surface extending from the upper portion to the lower portion may face the liquid fuel inlet port. The surface may have a concave curvature from the upper portion to the lower portion. The liquid fuel inlet port and the diffuser member may be disposed around a central axis.

A first portion of the surface near the upper portion of the diffuser member may have a first area, and a second portion of the surface near the lower portion of the diffuser member may have a second area larger than the first area. The diffuser member may be fixed to the housing, or to the liquid fuel inlet. The diffuser member may form a nozzle.

The fuel vaporization unit may include a heater unit in thermal contact with the liquid fuel space, and a liquid fuel level sensor in the lower portion. The evaporative liquid fuel of the fuel vaporization unit may be gasoline.

An embodiment of the invention also provides a method of generating vapor fuel in a fuel vaporization unit including a housing having a wall defining a chamber. The housing chamber has a lower portion and an upper portion. The method includes the steps of flowing a liquid fuel into the chamber through a first inlet port in the housing wall, flowing the liquid fuel by a stationary diffuser member, flowing a fuel vapor into the chamber through a second inlet port in the housing wall proximate the upper portion, forming vapor fuel in the upper portion of the chamber, and flowing the vapor fuel out of the chamber through an outlet port in the housing wall proximate the upper portion. The method may include the steps of forming a vacuum at the outlet port with an evaporative fuel vapor engine manifold, and heating the liquid fuel space.

### BRIEF DESCRIPTION OF THE DRAWINGS

The accompanying drawings, which are incorporated herein and constitute part of this specification, illustrate the presently preferred embodiments of the invention, and together with the general description given above and the detailed description given below, serve to explain features of the invention.

FIG. 1 is a schematic of a vapor fuel generation and management system for an evaporative fuel vapor engine, according to an embodiment of the invention.

FIG. 2 is a perspective view of a fuel vaporization unit of a vapor fuel generation and management system for an evaporative fuel vapor engine, according to an embodiment of the invention.

FIG. 3 is a cross-sectional view of the fuel vaporization unit of FIG. 2.

### DETAILED DESCRIPTION OF THE PREFERRED EMBODIMENTS

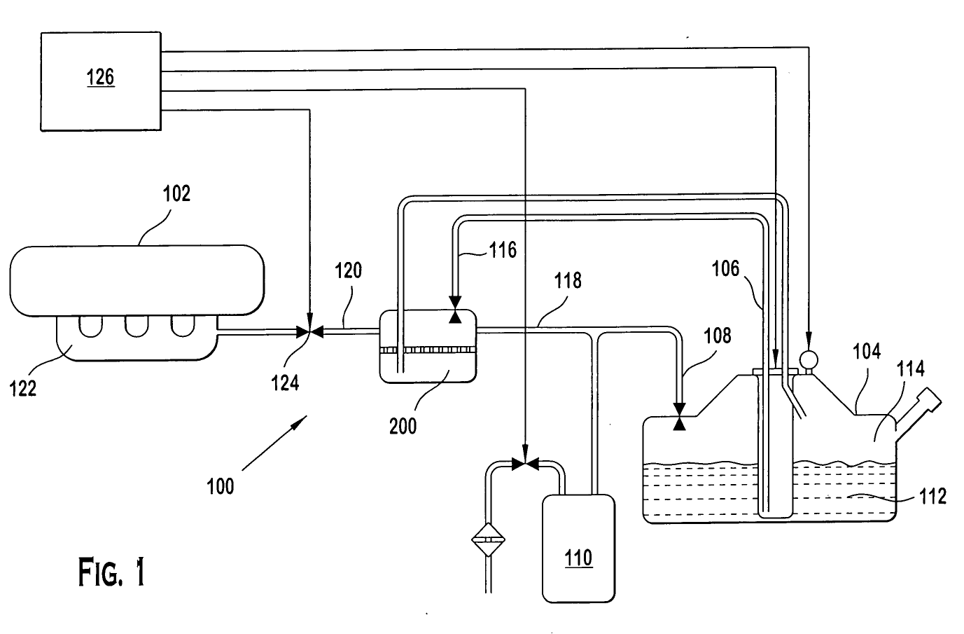

FIG. 1 illustrates a preferred embodiment of a vapor fuel generation and management system 100 for an evaporative fuel vapor engine. The vapor fuel generation and management system includes a fuel tank 104. Fuel tank 104 forms a chamber for storing an evaporative liquid fuel 112. Liquid fuel 112 may be gasoline, for example. Vapor from evaporative liquid fuel 112 is formed in the liquid fuel tank headspace 114. The amount of vapor formed in fuel tank headspace 114 is a function of vehicle dynamics, slosh, temperature, the type and grade of the evaporative liquid fuel in tank 104, and the pressure in tank 104. A fuel vapor collection canister 110, e.g. a carbon or charcoal canister, is in fluid communication with a fuel vapor outlet 108 of fuel tank 104. Vapor collection canister 110 absorbs and retains fuel vapor formed in fuel tank headspace 114, as is known in the art. Vapor collection canister 110, and the canister vent may be sized to provide adequate air flow for the system 100.

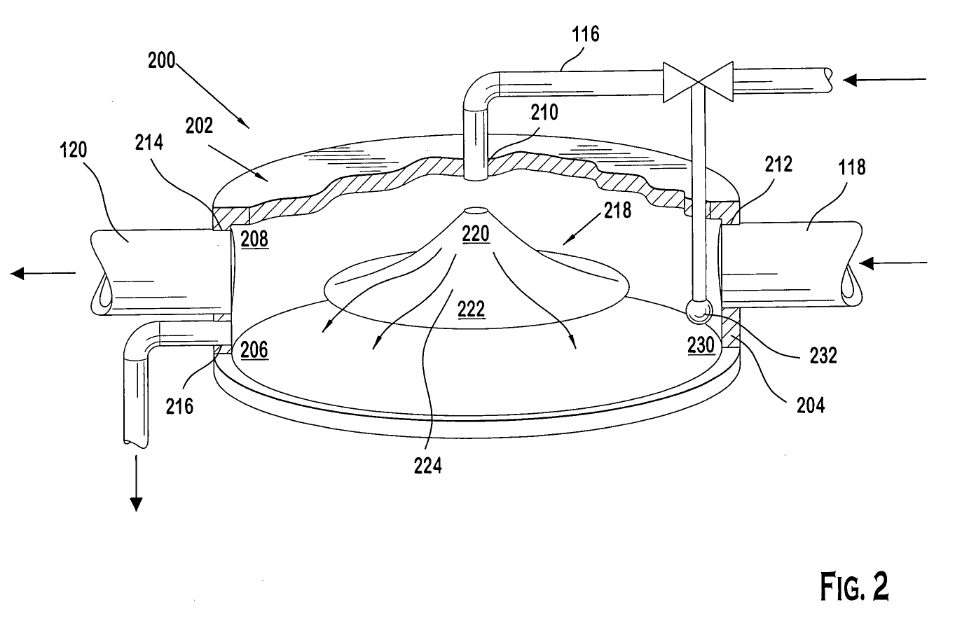

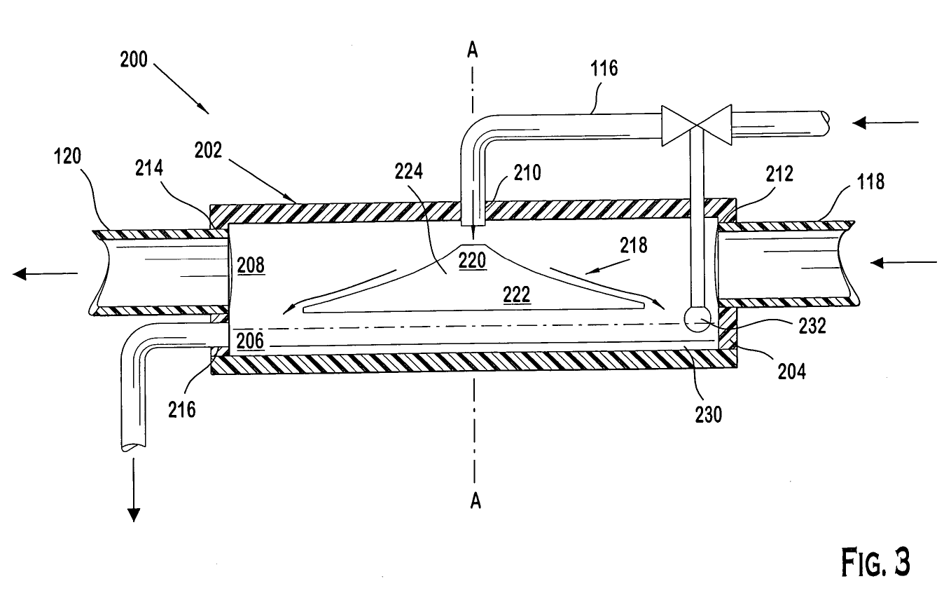

The vapor fuel generation and management system 100 includes a fuel vaporization unit 200. Fuel vaporization unit 200 is shown in FIGS. 2-3 in more detail, and is more fully described below. Fuel vaporization unit 200 generates a rich mixture of vapor fuel (i.e. a rich air/fuel mixture) from evaporative liquid fuel 112, and from a lean mixture of fuel vapor from vapor collection canister 110 and tank headspace 114, and supplies the rich mixture of vapor fuel to an engine intake manifold 122 of the evaporative fuel vapor engine 102. Evaporative liquid fuel 112 is supplied to fuel vaporization unit 200 through a liquid fuel inlet 116 that is in fluid communication with a liquid fuel outlet 106 of fuel tank 104. Fuel vapor collected in canister 110 is supplied to fuel vaporization unit 200 through a fuel vapor inlet 118 that is in fluid communication with vapor collection canister 110. Of course, the fuel vaporization unit 200 may be integrated with fuel tank 104 and vapor collection canister 110. Vapor fuel is supplied to engine intake manifold 122 through a vapor fuel outlet 120 in fuel vaporization unit 200. A purge valve 124 is controlled by an engine control unit 126, and regulates vapor fuel flow to engine intake manifold 122.

Referring to FIGS. 2 and 3, the fuel vaporization unit 200 includes a housing 202 formed of a wall 204 that defines a chamber. The housing chamber has a lower portion 206 and an upper portion 208. Lower portion 206 forms a liquid fuel space for collection of evaporative liquid fuel supplied through liquid fuel inlet 116 from liquid fuel outlet 106 of fuel tank 104. Upper portion 208 forms a vapor fuel space for collection of fuel vapor supplied through fuel vapor inlet 118 from vapor collection canister 110 and tank headspace 114, for collection of ambient air from the canister vent, and for collection of vapor fuel generated by fuel vaporization unit 200. The phantom line in FIG. 3 represents a phase interface between liquid fuel and vapor fuel. A liquid fuel inlet port 210 may be formed in housing wall 204 at the liquid fuel inlet 116. A fuel vapor inlet port 212 may be formed in housing wall 204 at the fuel vapor inlet 118 proximate upper portion 208. A vapor fuel outlet port 214 may be formed in housing wall 204 at the vapor fuel outlet 120 proximate upper portion 208. As shown, outlet port 214 is disposed on the housing wall 204 opposite the inlet port 212. However, outlet port 214 may be angularly disposed with respect to inlet port 212. For example, outlet port 214 may be disposed on housing wall 214 at a location that is 270 degrees around the housing wall 214 from inlet port 212. In this manner, air flow over a diffuser member 218 may be increased, as described below. A liquid fuel outlet port 216 may be formed in housing wall 204 proximate lower portion 206.

Fuel vaporization unit 200 includes diffuser member 218 at least partially disposed in upper portion 208 of housing 202. Diffuser member 218 is fixed in a stationary manner with respect to housing 202. Diffuser member 218 disperses liquid fuel supplied through liquid fuel inlet 116 to facilitate formation of a rich vapor fuel in upper portion 208 of housing 202. Diffuser member 218 is disposed around a central axis A-A, and has an upper portion 220, a lower portion 222, and a surface 224 extending from upper portion 220 to lower portion 222. Surface 224 has a concave curvature from the upper portion 220 to the lower portion 222. A central axis of liquid fuel inlet 116 may be colinear with axis A-A. Surface 224 faces the liquid fuel inlet port 116 so that liquid fuel flowing from liquid fuel inlet port 116 flows downwardly over surface 224, is dispersed outwardly from axis A-A and free-falls to lower portion 206 of housing 202. A lean mixture of fuel vapor entering the housing chamber from fuel vapor inlet 118 flows over the dispersed liquid fuel and generates a rich mixture of vapor fuel in upper portion 208 of housing 202. Engine control unit 126 may control a variable sender unit (not shown) that varies the rate of flow of liquid fuel supplied through liquid fuel inlet 116, to regulate the rate of generation of vapor fuel. A liquid fuel level sensor 232, that determines an amount of liquid fuel in lower portion 206 of the chamber, may be operatively connected to a control valve in the fuel inlet 116, to also control the rate of flow of liquid fuel supplied through liquid fuel inlet 116.

As described above, surface 224 has a concave curvature. However, it is to be understood that surface 224 may be of any form suitable for dispersing a liquid fuel. For example, surface 224 may have a convex curvature from upper portion 220 to lower portion 222, or surface 224 may be frustroconical in form. Surface 224 may have an upper portion having a first area, and a lower portion having a second area larger than the first area. The diffuser member 218 may be fixed in a stationary manner with respect to housing 202 in any suitable way. For example, diffuser member 218 may be fixed directly to housing 202, or diffuser member 218 may be fixed to the liquid fuel inlet 116. Diffuser member 218 may be any member suitable for dispersing liquid fuel supplied through liquid fuel inlet 116. For example, the diffuser member 218 may be a nozzle fixed to liquid fuel inlet 116.

Fuel vaporization unit 200 may vaporize liquid fuel by increasing the temperature of the liquid fuel. The fuel vaporization unit 200 may include a heater unit 230 in thermal contact with the liquid fuel bath, the inlet 116, or the diffuser member 218. Heater unit 230 facilitates vaporization of the liquid fuel by increasing the temperature of the liquid fuel. Fuel vaporization unit 200 may vaporize liquid fuel, for example, by increasing the free surface area of the liquid fuel, or by increasing vapor flow over the free surface of the liquid fuel.

Operation of a vapor fuel generation and management system, according to principles of the invention, provides a vapor fuel generation and management system for an evaporative fuel vapor engine, that generates and supplies sufficient vapor fuel to sustain operation of the engine without the need for a separate liquid fuel supply to the engine cylinders, such as fuel injectors and a fuel rail. Evaporative liquid fuel 112 may be stored in fuel tank 104 and may form vapor in fuel tank headspace 114. Vapor collection canister 110 absorbs and retains the fuel vapor formed in fuel tank headspace 114. Evaporative liquid fuel 112 is supplied to fuel vaporization unit 200 from liquid fuel outlet 106 through liquid fuel inlet 116. Liquid fuel 112 is flowed over diffuser member 218 and dispersed. A lean mixture of fuel vapor enters the housing chamber from fuel vapor inlet 118, flows over the dispersed liquid fuel, and generates a rich mixture of vapor fuel in upper portion 208 of housing 202. A vacuum at engine intake manifold 122 draws the vapor fuel (e.g. an air fuel mixture) through vapor fuel outlet 120 and into intake manifold 122 for combustion. Purge valve 124 is controlled by an engine control unit 126, and may regulate all the vapor fuel flow to engine intake manifold 122. The invention provides a vapor fuel generation and management system for an evaporative fuel vapor engine, that improves utilization of hydrocarbon vapor, and reduces hydrocarbon emissions through the tail pipe of an automobile.

While the invention has been disclosed with reference to certain preferred embodiments, numerous modifications, alterations, and changes to the described embodiments are possible without departing from the sphere and scope of the invention, as defined in the appended claims and their equivalents thereof. Accordingly, it is intended that the invention not be limited to the described embodiments, but that it have the full scope defined by the language. of the following claims.

1. A vapor fuel generation and management system for an evaporative fuel vapor engine, comprising:
a fuel tank that defines a chamber adapted to store an evaporative liquid fuel, the fuel tank having a liquid fuel outlet and a fuel vapor outlet;
a carbon canister in communication with the fuel vapor outlet of the fuel tank;
a fuel vaporization unit that generates vapor fuel, the fuel vaporization unit including a stationary diffuser member, the fuel vaporization unit having a liquid fuel inlet in communication with the liquid fuel outlet of the fuel tank, a fuel vapor inlet in communication with the carbon canister, and a vapor fuel outlet in communication with an engine intake manifold, the liquid fuel inlet disposed to flow the liquid fuel on the diffuser member; and
a purge valve that controls vapor fuel flow to the engine intake manifold.

2. The vapor fuel generation and management system of claim 1, wherein the fuel vaporization unit includes:
a housing having a wall defining a chamber, the housing chamber having a lower portion and an upper portion, the lower portion forming a liquid fuel space, the upper portion forming a vapor fuel space.

3. The vapor fuel generation and management system of claim 2, wherein
the liquid fuel inlet of the fuel vaporization unit includes a first port in the housing wall;
the fuel vapor inlet of the fuel vaporization unit includes a second port in the housing wall proximate the upper portion; and
the vapor fuel outlet of the fuel vaporization unit includes a third port in the housing wall proximate the upper portion.

4. The vapor fuel generation and management system of claim 3, wherein the fuel vaporization unit includes a liquid fuel outlet in communication with a liquid fuel inlet of the fuel tank.

5. The vapor fuel generation and management system of claim 4, wherein the liquid fuel outlet of the fuel vaporization unit includes a fourth port in the housing wall proximate the lower portion.

6. The vapor fuel generation and management system of claim 5, wherein the fuel vaporization unit includes a liquid fuel level sensor in the lower portion.

7. The vapor fuel generation and management system of claim 1, wherein the evaporative liquid fuel is gasoline.

8. A fuel vaporization unit of a vapor fuel generation and management system for an evaporative fuel vapor engine, comprising:
a housing having a wall defining a chamber, the housing chamber having a lower portion and an upper portion, the lower portion forming a liquid fuel space, the upper portion forming a vapor fuel space;
a liquid fuel inlet port in the housing wall that receives liquid fuel from a liquid fuel tank;
a fuel vapor inlet port in the housing wall proximate the upper portion;
a vapor fuel outlet port in the housing wall proximate the upper portion; and
a stationary diffuser member at least partially disposed in the upper portion, the stationary diffuser member for dispersing flow of the liquid fuel from the liquid fuel inlet port.

9. The fuel vaporization unit of claim 8, wherein the diffuser member includes an upper portion, a lower portion, and a surface extending therebetween, the surface facing the liquid fuel inlet port.

10. A fuel vaporization unit of a vapor fuel generation and management system for an evaporative fuel vapor engine, comprising:
a housing having a wall defining a chamber, the housing chamber having a lower portion and an upper portion, the lower portion forming a liquid fuel space, the upper portion forming a vapor fuel space;
a liquid fuel inlet port in the housing wall;
a fuel vapor inlet port in the housing wall proximate the upper portion;
a vapor fuel outlet port in the housing wall proximate the upper portion; and
a stationary diffuser member at least partially disposed in the upper portion for dispersing flow of liquid fuel, the diffuser member including an upper portion, a lower portion, and a surface having a concave curvature from the diffuser member upper portion to the diffuser member lower portion, the surface facing the liquid fuel inlet port.

11. The fuel vaporization unit of claim 10, wherein the liquid fuel inlet port and the diffuser member are disposed around a central axis.

12. A fuel vaporization unit of a vapor fuel generation and management system for an evaporative fuel vapor engine, comprising:
a housing having a wall defining a chamber, the housing chamber having a lower portion and an upper portion, the lower portion forming a liquid fuel space, the upper portion forming a vapor fuel space;
a liquid fuel inlet port in the housing wall;
a fuel vapor inlet port in the housing wall proximate the upper portion;
a vapor fuel outlet port in the housing wall proximate the upper portion; and
a stationary diffuser member at least partially disposed in the upper portion for dispersing flow of liquid fuel, the diffuser member including an upper portion, a lower portion, and a surface extending therebetween and facing the liquid fuel inlet port, wherein a first portion of the surface proximate the upper portion of the diffuser member has a first area and a second portion of the surface proximate the lower portion of the diffuser member has a second area, the second area being more than the first area.

13. The fuel vaporization unit of claim 8, wherein the diffuser member is fixed to one of the housing and the liquid fuel inlet.

14. The fuel vaporization unit of claim 13, wherein the diffuser member comprises a nozzle.

15. The fuel vaporization unit of claim 8, further comprising:
a heater unit in thermal contact with the lower portion.

16. The fuel vaporization unit of claim 8, further comprising:
a liquid fuel outlet port in the housing wall proximate the lower portion.

17. The fuel vaporization unit of claim 8, further comprising:
a liquid fuel level sensor in the lower portion.

18. The fuel vaporization unit of claim 8, wherein the evaporative liquid fuel is gasoline.

19. A method of generating vapor fuel in a fuel vaporization unit for an evaporative fuel vapor engine, the fuel vaporization unit including a housing having a wall defining a chamber, the housing chamber having a lower portion and an upper portion, comprising:
flowing a liquid fuel into the chamber from a liquid fuel tank through a first inlet port in the housing wall;
flowing the liquid fuel from the first inlet port on a stationary diffuser member;
flowing a fuel vapor into the chamber through a second inlet port in the housing wall proximate the upper portion;
forming vapor fuel in the upper portion of the chamber; and
flowing the vapor fuel out of the chamber through an outlet port in the housing wall proximate the upper portion.

20. The method of generating vapor fuel of claim 19, wherein the steps of flowing a fuel vapor into the chamber, and flowing the vapor fuel out of the chamber includes:
forming a vacuum at the outlet port with an evaporative fuel vapor engine manifold.

21. The method of generating vapor fuel of claim 19, comprising:
heating the liquid fuel bath with a heater unit.
